(19) United States
(12) Patent Application Publication
(10) Pub. No.: US 2006/0024577 A1
(43) Pub. Date: Feb. 2, 2006

(54) Electrolyte solution and use thereof

(76) Inventor: Andree Schwake, Heidenheim (DE)

Correspondence Address: FISH & RICHARDSON PC, P.O. BOX 1022, MINNEAPOLIS, MN, 55440-1022, US

(21) Appl. No.: 10/508,284

(22) PCT Filed: Mar. 13, 2003
(86) PCT No.: PCT/DE03/00815

§ 371 Date: Jun. 17, 2005

(30) Foreign Application Priority Data
Mar. 21, 2002 (DE) 102 12 609.7

(51) Int. Cl. H01M 6/04

(52) U.S. Cl. 429/188

(57) ABSTRACT

An electrolyte solution for electrochemical cells having a high boiling point >86° C. at 1 bar and a high conductivity >40 mS/cm at 25° C. is proposed that comprises not only acetonitrile with a proportion of 40-90 wt.-% of the solvent weight as a first solvent (component A) but also at least a second electrochemically stable solvent having a boiling point >120° C. at 1 bar, a dielectric constant >10 at 25° C., and a viscosity <6 mPas at 25° C., as well as at least one conductive salt as component C). Such electrolyte solutions according to the invention demonstrate high conductivity values that are comparable to those of electrolyte solutions that use acetonitrile as the sole solvent. At the same time, however, because of component B) they also demonstrate elevated boiling points.

Electrolyte solutions that contain acetonitrile as the solvent are frequently used in electrochemical cells, for example capacitors or batteries. Acetonitrile has a high polarity (dielectric constant DC=37.5 at 25° C.) at a very low viscosity (0.325 mPas at 25° C.). Because of the high polarity of the acetonitrile, the latter supports the disassociation of the conductive salts that have at the same time a high mobility in the electrolyte solution because of the low viscosity of the acetonitrile, particularly well, so that electrolyte solutions with acetonitrile as the sole solvent achieve a very high conductivity. An electrolyte that consists, for example, of 0.9 M tetraethyl ammonium tetrafluoroborate in 100% acetonitrile as the solvent, has a conductivity of 55.1 mS/cm at 25° C. Electrolytes without acetonitrile as the solvent have a much lower conductivity. An electrolyte solution consisting of 0.9 M tetraethyl ammonium tetrafluoroborate in 100% propylene carbonate, for example, has a conductivity of only 13.7 mS/cm at 25° C.

The disadvantage of electrolyte solutions that use acetonitrile as the solvent lies in the relatively low boiling point of the acetonitrile (81.6° C at 1 bar). This boiling point is increased only slightly by adding the conductive salt, so that in the case of electrolyte solutions containing acetonitrile, boiling points of about 84° C. are obtained. Because of these low boiling points, the top usage temperature of electrochemical cells that contain electrolyte containing acetonitrile is limited to a maximum of 70° C., because at higher temperatures the internal pressure of the electrochemical cells increases so much that deformation of the housing and a response of the pressure relief valve or the planned breakage point can occur. In the case of deformation of the housing, the ability of the electrochemical cell to function properly can no longer be guaranteed. If the pressure relief valve or the planned breakage point responds, acetonitrile vapors will reach the 5 atmosphere, and these represent a high safety risk due to the potential risk of fire and explosion. Furthermore, electrochemical cells that have a usage temperature of >85° C. are required nowadays.

In the U.S. Pat. No. 5,418,682, electrolyte solutions containing glutaronitrile mixed with another dinitrile as the solvent are described as having usage temperatures up to 150° C. It is true that glutaronitrile as well as other dinitriles demonstrate high dielectric constants, but at the same time they also demonstrate a high viscosity because of their high boiling points. For this reason, such electrolyte solutions demonstrate only low conductivity values. For example, an electrolyte consisting of 1 M tetraethyl ammonium tetrafluoroborate, with glutaronitrile and succinonitrile as the solvents, has a low conductivity of only 7.19 mS/cm at room temperature.

Furthermore, it is possible to use salts that are molten at room temperature and that do not require a solvent, in electrochemical cells that are to be used at temperatures above 70° C. These molten salts, for example 1-ethyl-3-methylimidazolium tetrafluoroborate, have high boiling points of 200° C., for example, but also have only low conductivity values, which amount to about 13 mS/cm at 25° C. in the case of the aforementioned molten salt (Journal of the Electrochemical Society (1999), 146 (5), 1687-1695).

It is the task of the present invention to provide an electrolyte solution having a high conductivity simultaneously with a high boiling point that avoids the disadvantages of known electrolyte solutions and demonstrates a usage temperature of >85° C.

This task is accomplished by means of an electrolyte solution having the characteristics of claim 1. Advantageous embodiments of the electrolyte solution, as well as its use, are the object of additional claims.

An electrolyte solution according to the invention has a boiling point of greater than 86° C. at 1 bar as well as a conductivity of greater than 40 mS/cm at 25° C. and which comprises, as component A), acetonitrile with a proportion of 40-90 wt.-% of the solvent weight, and, as component B), at least a second electrochemically stable solvent having a boiling point >120° C. at 1 bar pressure, a dielectric constant >10 at 25° C., and a viscosity <6 mPas at 25° C. At least one conductive salt is added as component C).

The inventor has recognized that, surprisingly, electrolyte solutions having a high conductivity and simultaneously a high boiling point can be implemented in that acetonitrile as component A) is combined with at least one other solvent as component B) that has a boiling point of greater than 120° C. at 1 bar. Because of the elevated boiling point of this component B), the boiling point of the entire electrolyte solution is raised, so that a boiling point of greater than 86° C. results for the entire electrolyte solution.

Aside from the high boiling point, greater than 120° C., component B) must furthermore have a certain viscosity <6 mPas at 25° C. and a dielectric constant >10 at 25° C. Thus component B) has a greater viscosity in comparison with acetonitrile, so that a person skilled in the art would expect that electrolyte solutions having this solvent component would demonstrate significantly lower conductivity values than electrolyte solutions having acetonitrile as the sole solvent. Nevertheless, component B) in the electrolyte solutions according to the invention has a dissociating effect on the conductive salt because of its sufficient polarity and, at the same time, guarantees continued good mobility in the electrolyte solutions of the ions formed because of its relatively low viscosity, so that a surprisingly high conductivity of the electrolyte solutions according to the invention is the result. Surprisingly, the inventor therefore succeeded in obtaining electrolyte solutions that demonstrate only the desired positive characteristics of the acetonitrile (high conductivity) and of the component B) (high boiling point), in each instance, without, vice versa, the undesirable properties of the two components (acetonitrile=low boiling point; component B)=low conductivity) being very influential. In this connection, electrolyte solutions according to the invention have a high conductivity that lies approximately in the range of electrolyte solutions that use acetonitrile as the sole solvent but at the same time have a high boiling point that could not previously be achieved with electrolyte solutions containing acetonitrile.

Furthermore, the solvent of component B) must be electrochemically stable so that it is not decomposed, either by oxidation or reduction, at the charged surfaces of the electrodes during operation of the electrochemical cells. The electrochemical stability of electrolytes and their solvents can be determined, for example, by means of recording cyclovoltammograms. The precise determination of the electrochemical stability of electrolytes and solvents is described, for example, in the publication in the journal Electrochimica Acta (2001), 46, 1823-1827, and reference to the full content of this reference is hereby made.

The dielectric constant of a solvent can be determined in a decameter using methods that are known to a person skilled in the art. They are presented, for example, in Römpp's Chemielexikon [Encyclopedia of Chemistry] (9^{th} edition), under the term “Dielektrizitätskonstante” [dielectric constant] (page 955-956), and reference to the full content of this reference is also hereby made.

The viscosity of a solvent can be determined, for example, in a manner with which a person skilled in the art is familiar, by means of an Ubbelohde viscosimeter. The boiling points of solvents can also be determined in simple manner, by means of determining the temperature of the boiling liquid.

Component B) is advantageously selected from among the following solvents: ethylene carbonate, propylene carbonate, γ-butyrolactone, γ-valerolactone, butylene carbonate, sulfolan, 3-methyl sulfolan, dimethyl sulfoxide, glutaronitrile, succinonitrile, 3-methoxy proprionitrile, diethyl carbonate, ethyl methyl carbonate, trimethyl phosphate, N-methyl pyrrolidinone, N-methyl oxazolidinone, N,N-dimethyl imidazolidinone, dimethyl formamide, and dimethyl acetamide.

It is advantageous if the proportion of the component B) in the solvent weight is about 10 to 60 wt.-%, preferably 10 to 50 wt.-% (without the conductive salt). This means that at the same time acetonitrile is present in a preferred proportion of 50 to 90 wt.-%. In this way, it can be assured that electrolyte solutions according to the invention have a high conductivity on the one hand because of a sufficiently high proportion of acetonitrile, but at the same time also a high boiling point because of a high proportion of the component B).

The conductive salts as component C) are selected from among combinations of specific anions and cations. Possible anions are borate, for example tetrafluoroborate, fluoroalkyl phosphate, PF₆⁻, AsF₆⁻, SbF₆⁻, fluoroalkyl arsenate, fluoroalkyl antimonate, trifluoromethyl sulfonate, bis(trifluoromethane sulfon)imide, tris(trifluoromethane sulfonyl)methide, perchlorate, tetrachloroaluminate, and anions having B(OR)₄⁻, for example oxalatoborate, whereby R is an alkyl group that can also be bridged with other OR groups. Possible cations to be used generally include the ammonium cation, for example tetraalkyl ammonium cation, the phosphonium cation and its tetraalkyl cations, the pyridinium cation, morpholinium, lithium, imidazolium cations and pyrrolidinium cations. The salts can also be molten at room temperature.

In the case of electrolytes according to the invention, tetraethyl ammonium tetrafluoroborate is frequently used as component C), in other words as the conductive salt, since it is particularly soluble in the solvents of the electrolyte solutions according to the invention, is easily available and guarantees high conductivity.

In the following, the invention will be explained in greater detail using exemplary embodiments. In the related Table 1, the composition of 21 electrolyte solutions according to the invention is indicated, along with their boiling points at 1 bar in each instance, and their conductivity at 25° C., and compared with a conventional electrolyte solution. For the two solvent components A) and B), the wt.-% are indicated after the colon in each instance; the weight of the conductive salt is not taken into consideration here. A conventional electrolyte solution that contains acetonitrile as the sole solvent serves as Comparison Example 1. In all the exemplary embodiments of the invention, as well as in the conventional electrolyte solution, tetraethyl ammonium tetrafluoroborate is used as the conductive salt, in a concentration of 1.2 mol per liter. In this connection, the conductive salt can also be replaced with the other conductive salts mentioned above without any great changes in conductivity.

Abbreviations: AC=acetonitrile, PC=propylene carbonate, EC=ethylene carbonate, γ-B.=γ-butyrolactone, DMSO=dimethyl sulfoxide, MPN=3-methoxy proprionitrile, GN=glutaronitrile, TEATFB=tetraethyl ammonium tetrafluoroborate.

TABLE 1

| | | | | Boiling | |
|---|---|---|---|---|---|
| | | | | Temperature | Conductivity |
| Example No. | Component A | Component B | Component C | [° C.] | [mS/cm] |
| 1 | AC: 100 | — | 1.2 M TEATFB | 84.5 | 61.7 |
| 2 | AC: 90 | γ-B.: 10 | 1.2 M TEATFB | 91 | 58 |
| 3 | AC: 80 | γ-B.: 20 | 1.2 M TEATFB | 88 | 54.9 |
| 4 | AC: 70 | γ-B.: 30 | 1.2 M TEATFB | 93.5 | 50.9 |
| 5 | AC: 60 | γ-B.: 40 | 1.2 M TEATFB | 95 | 46.8 |
| 6 | AC: 50 | γ-B.: 50 | 1.2 M TEATFB | 101 | 42.9 |
| 7 | AC: 90 | PC: 10 | 1.2 M TEATFB | 87 | 58.5 |
| 8 | AC: 80 | PC: 20 | 1.2 M TEATFB | 88.5 | 54.2 |
| 9 | AC: 70 | PC: 30 | 1.2 M TEATFB | 91.5 | 50.3 |
| 10 | AC: 90 | EC: 10 | 1.2 M TEATFB | 86 | 59.7 |
| 11 | AC: 80 | EC: 20 | 1.2 M TEATFB | 88 | 57.2 |
| 12 | AC: 70 | EC: 30 | 1.2 M TEATFB | 90 | 53.5 |
| 13 | AC: 50 | EC: 50 | 1.2 M TEATFB | 98.5 | 44.2 |
| 14 | AC: 90 | GN: 10 | 1.2 M TEATFB | 86.5 | 58.5 |
| 15 | AC: 80 | GN: 20 | 1.2 M TEATFB | 88 | 57.2 |
| 16 | AC: 70 | GN: 30 | 1.2 M TEATFB | 90.5 | 45.9 |
| 17 | AC: 50 | DMSO: 50 | 1.2 M TEATFB | 101 | 40.5 |
| 18 | AC: 50 | MPN: 50 | 1.2 M TEATFB | 100 | 40.4 |
| 19 | AC: 50 | γ-B.: 40; MPN: 10 | 1.2 M TEATFB | 100 | 41.7 |
| 20 | AC: 50 | γ-B.: 40; EC: 10 | 1.2 M TEATFB | 99 | 42.6 |
| 21 | AC: 50 | γ-B.: 30; MPN: 30 | 1.2 M TEATFB | 100 | 41.3 |
| 22 | AC: 50 | γ-B.: 30; MPN: 20 | 1.2 M TEATFB | 100.5 | 41.3 |

The electrolytes according to the invention in the exemplary embodiments comprise an entire series of solvents as component B), for example γ-butyrolactone, propylene carbonate, ethylene carbonate, glutaronitrile, dimethyl sulfoxide, 3-methoxy proprionitrile, or a mixture of γ-butyrolactone and 3-methoxy proprionitrile, or a mixture of γ-butyrolactone and ethylene carbonate.

A particularly high boiling point of 101° C. with a simultaneously high conductivity of 42.9 mS/cm at 25° C. can be achieved with approximately equal weight proportions of acetonitrile and γ-butyrolactone as component B), as well as tetraethyl ammonium tetrafluoroborate in a concentration of about 0.9 to 1.2 mol per liter as component C). In this connection, the proportion of the acetonitrile can vary between 50 to 60 weight percent and the proportion of the γ-butyrolactone can vary between 40 to 50 weight percent.

To determine the electrical data of double-layer capacitors having electrolyte solutions according to the invention, electrochemical double-layer capacitors were impregnated with an electrolyte solution according to the invention in accordance with Example 6, their electrical data were determined and compared with those of the known comparison electrolyte solution No. 1. The corresponding data are shown in Table 2.

TABLE 2

| Example No. | Capacitance [farad] | ESR [mΩ] |
|---|---|---|
| 1 | 129 | 6.41 |
| 6 | 125 | 8.90 |

It turns out that capacitors having electrolyte solutions according to the invention continue to demonstrate an acceptable serial resistance (ESR) at simultaneously high capacitance, which values are comparable with values for conventional capacitors. In contrast to the conventional capacitors, however, capacitors having the electrolyte solutions according to the invention demonstrate significantly higher usage temperatures. The electrolyte solutions according to the invention can also be used in primary and secondary Li batteries and/or Li ion batteries. These then also demonstrate higher usage temperatures because of the electrolyte solution.

The invention is not limited to the exemplary embodiments presented here. Other electrolyte compositions having other components B) and other conductive salts in different mixture ratios also lie within the scope of the invention.

1. An electrolyte solution for use with an electrochemical cell, the electrolyte solution having a boiling point greater than 86° C. at 1 bar and a conductivity greater than 40 mS/cm at 25° C., the electrolyte solution comprising:
a first solvent comprising acetonitrile at 40-90 wt.-%;
at least one additional electrochemically stable solvent having a boiling point [[>]] greater than 120° C. at 1 bar, a [[DC >]] dielectric constant greater than 10 at 25° C., and a viscosity less than 6 mPas at 25° C.; and
at least one conductive salt.

2. The electrolyte solution of claim 1, wherein the at least one additional electrochemically stable solvent is selected from among the following solvents:
ethylene carbonate, propylene carbonate, γ-butyrolactone, γ-valerolactone, butylene carbonate, sulfolan, 3-methyl sulfolan, dimethyl sulfoxide, glutaronitrile, succinonitrile, 3-methoxy proprionitrile, diethyl carbonate, ethyl methyl carbonate, trimethyl phosphate, N-methyl pyrrolidinone, N-methyl oxazolidinone, N,N-dimethyl imidazolidinone, dimethyl formamide, and dimethyl acetamide.

3. The electrolyte solution of claim 1, wherein the at least one additional electrochemically stable solvent comprises 10-60 wt.-% of the electrolyte solution.

4. The electrolyte solution of claim 1, wherein the at least one conductive salt is selected from paired combinations of the following anions and cations:
anions: borate, tetrafluoroborate, fluoroalkyl phosphate, PF₆⁻, AsF₆⁻, SbF₆⁻, fluoroalkyl arsenate, fluoroalkyl antimonate, trifluoromethyl sulfonate, bis(trifluoromethane sulfon)imide, tris(trifluoromethane sulfonyl) methide, perchlorate, tetrachloroaluminate, oxalatoborate, and anions having B(OR)₄⁻, whereby R is an alkyl group that can also be bridged with other OR groups,
cations: ammonium cation, tetraalkyl ammonium cation, phosphonium cation, tetraalkyl phosphonium cation, pyridinium cation, morpholinium cation, lithium cation, imidazolium and pyrrolidinium.

5. The electrolyte solution of claim 1, wherein the at least one conductive salt comprises tetraethyl ammonium tetrafluoroborate.

6. The electrolyte solution of claim 1, wherein the at least one additional electrochemically stable solvent comprises γ-butyrolactone.

7. The electrolyte solution of claim 1, wherein the at least one additional electrochemically stable solvent comprises propylene carbonate.

8. The electrolyte solution of claim 1, wherein the at least one additional electrochemically stable solvent comprises ethylene carbonate.

9. The electrolyte solution of claim 1, wherein the at least one additional electrochemically stable solvent comprises glutaronitrile.

10. The electrolyte solution of claim 1, wherein the at least one additional electrochemically stable solvent comprises dimethyl sulfoxide.

11. The electrolyte solution of claim 1, wherein the at least one additional electrochemically stable solvent comprises 3-methoxy proprionitrile.

12. The electrolyte solution of claim 1, wherein the at least one additional electrochemically stable solvent comprises a mixture of γ-butyrolactone and 3-methoxy proprionitrile.

13. The electrolyte solution of claim 1, wherein the at least one additional electrochemically stable solvent comprises a mixture of γ-butyrolactone and ethylene carbonate.

14. The electrolyte solution of claim 1,
wherein acetonitrile is present in the first solvent at about 50-60 wt.-%;
wherein the at least one additional electrochemically stable solvent comprises γ-butyrolactone in a proportion of abut 40-50 wt.-%; and
wherein the at least one conductive salt comprises tetraethyl ammonium tetrafluoroborate in a concentration of about 0.9 to 1.2 mol/l.

15. The electrolyte solution of claim 1, wherein the electrochemical cell comprises a capacitor.

16. The electrolyte solution of claim 1, wherein the electrochemical cell comprises an electrochemical double-layer capacitor.

17. The electrolyte solution of claim 1, wherein the electrochemical cell comprises a battery.

18. The electrolyte solution of claim 17, wherein the battery comprises at least one of a primary Li battery, a secondary Li battery, and an Li ion battery.
